(19) United States
(12) Patent Application Publication
(10) Pub. No.: US 2004/0054550 A1
(43) Pub. Date: Mar. 18, 2004

(54) System and method for the distribution of information during irregular operations

(76) Inventors: James Cole, East Setauket, NY (US); Matthew Marcella, West Hempstead, NY (US); Ron Dunsky, Brooklyn, NY (US); Peter Gerlett, Long Beach, NY (US)

Correspondence Address: Fay Kaplun & Marcin, LLP, Suite 702, 150 Broadway, New York, NY, 10038, US

(21) Appl. No.: 10/408,175

(22) Filed: Apr. 4, 2003

Related U.S. Application Data
(60) Provisional application No. 60/370,629, filed on Apr. 4, 2002.

(51) Int. Cl. G06F 17/60

(52) U.S. Cl. 705/1

(57) ABSTRACT

A system, comprising a first computing device receiving data from an input feed, the data corresponding to operating parameters of an airport facility, the first computing device organizing the data into files which are viewable by users of the system and an additional computing device connected via a communication network to the first computing device, receiving the files organized by the first computing device and displaying the files to a user.

### INCORPORATION BY REFERENCE

This application claims the benefit of U.S. Provisional Patent Application No. 60/370,629 filed on Apr. 4, 2002 and entitled “System and Method for the Distribution of Information During Irregular Operations” and is expressly incorporated herein, in its entirety, by reference.

### BACKGROUND INFORMATION

The slightest of irregular conditions at an airport may cause hours of delay and schedule disruptions for passengers, loss of revenue and extra costs for airlines and airports and general confusion as to the status of the airport. Irregular conditions may be a wide variety of conditions such as severe weather conditions, emergencies, security breaches, etc. The problems associated with these irregular operations lead to major losses of efficiency for air travelers. The airlines lose revenue because not as many flights can takeoff and land from an airport facility and incur higher costs due to extra staffing and passenger compensation as a result of the passenger confusion caused by the disruptions. The airports lose revenue because the number of takeoffs and landings are reduced during these irregular operations.

These irregular conditions usually lead to airport problems because of a lack of communication between airlines, the airport and governmental agencies and the lack of access to information pertaining to these conditions. Each of these parties have independent communication systems which do not allow for communication interconnection and the sharing of information. The sharing of information among these parties would allow the airport to return to normal operations as quickly as possible after the occurrence of an irregular condition.

### SUMMARY OF THE INVENTION

A system, comprising a first computing device receiving data from an input feed, the data corresponding to operating parameters of an airport facility, the first computing device organizing the data into files which are viewable by users of the system and an additional computing device connected via a communication network to the first computing device, receiving the files organized by the first computing device and displaying the files to a user.

In addition, a method, comprising the steps of collecting data corresponding to operating parameters of an airport facility, organizing the data into files which are viewable by users and distributing the files to a user device for the user to display the files.

Furthermore, a system, comprising a data receiving arrangement to receive data corresponding to operating parameters of an airport facility, a data storage arrangement to store the data received by the data receiving arrangement, a data organizing arrangement to associate each piece of data with a corresponding file and a data distribution arrangement to distribute the file to users of the system.

### BRIEF DESCRIPTION OF DRAWINGS

FIG. 1 shows an exemplary system according to the present invention;

FIG. 2 shows an exemplary user station according to the present invention;

FIG. 3 shows an exemplary screen shot of a departure slot allocation screen according to the present invention;

FIG. 4 shows an exemplary screen shot of a airline/terminal operator screen according to the present invention;

FIG. 5 shows an exemplary screen shot of an airport authority landslide operations screen according to the present invention;

FIG. 6 shows an exemplary screen shot of airport authority airfield conditions screen according to the present invention;

FIG. 7 shows an exemplary update of information across different pages according to the present invention;

FIG. 8 shows an exemplary embodiment of a regional IROPSnet system which includes three airport facilities, a regional airport authority facility and an FAA operation center according to the present invention;

FIG. 9 shows an exemplary system operation process for the operation of an exemplary IROPSnet system according to the present invention;

FIG. 10 shows an exemplary process for re-allocating departure slots using the system according to the present invention;

FIG. 11 shows a first exemplary view of a Master Coordination Screen according to the present invention;

FIG. 12 shows a second exemplary view of a Master Coordination Screen according to the present invention;

FIG. 13 shows an exemplary view of a Master Coordination Screen including a pop-up box according to the present invention.

### DETAILED DESCRIPTION

The present invention may be further understood with reference to the following description of preferred exemplary embodiments and the related appended drawings, wherein like elements are provided with the same reference numerals. During severe weather or other irregular events that may restrict aviation traffic, airlines and airports need to retrieve and assess information pertaining to those conditions. The exemplary embodiment of the present invention provides a central, easily accessible, and automatically updated collection and distribution technology for vital airport and airline information during weather and other irregular operations. The present invention comprises a system and method for a communications network-based information storage and sharing database and application for use during irregular operations of an airport or airline. The irregular operations network (“IROPSnet”) enables airports, airlines, government agencies and other authorized entities (the “user(s)”) to constantly update and share mission-critical information via a communications network, e.g., the Internet, an airport intranet, etc., during irregular operations.

The exemplary embodiment of the present invention comprises a fast-communications network which is custom designed for the specific needs of airlines and airports during irregular operations. It is designed to cover all major airlines and airport operational functions affected during weather and other irregular operations. Information such as, for example, status of ground and air operations, runway activity, departure slot allocation schedule, taxiway routes, arrival and departure rates, and snow removal strategy and equipment status, may be provided by the IROPSnet via a communications network. The information may be viewed through the use of programs that access and display files and other data available on the communications network such as, for example, a web browser. The IROPSnet may be accessible by a plurality of users such as, for example, airlines, terminal operators, Federal Aviation Authority (“FAA”) towers, as well as other approved parties (e.g., airline system operation centers). Some of the information may also be made available to the general public.

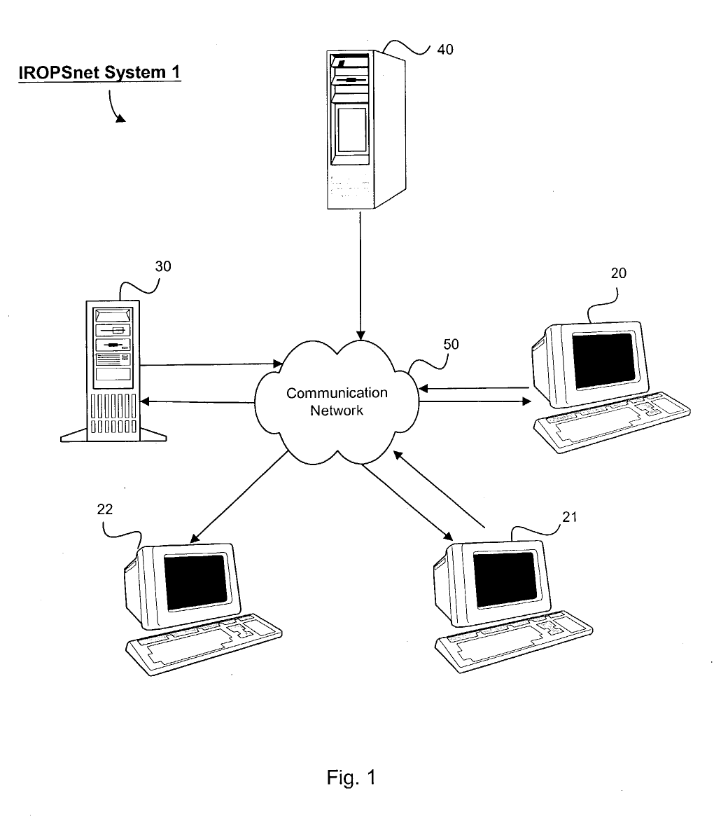

FIG. 1 shows an exemplary system 1 according to the present invention. The system includes a main server 30 for storing the main database and hosting the web page (or other data distribution system) to distribute the irregular operation information. The main server 30 may be, for example, a standard PC based server system running an operating system such as LINUX. Those of skill in the art will understand that any computing platform may be used for the main server 30. The function of the main server 30 may also be distributed among a plurality of servers. The main server 30 may be connected to a communications network 50, for example, the Internet. A plurality of user's stations 20-22 may also be connected to the communication network 50. The user's stations 20-22 may be, for example, personal computers (“PCS”) or other computing platforms having network or modem access. In addition, a data feed arrangement 40 may be connected to the communications network 50. In an alternative embodiment, the data feed arrangement 40 is connected directly to the main server 30. Each of the components of system 1 will be described in greater detail below.

The main server 30 may contain one or more databases containing relevant irregular operations information. In the present description, the term database will be used to describe any manner of storing data or information including those manners other than a traditional database structure. The main server 30 may utilize a database server for the permanent or temporary logging and storage of every piece of information entered into the system 1 using a common industry language, such as, for example, standard query language (“SQL”). The main server 30 may also contain web server software to allow the main server 30 to host a web page or series of web pages in order to make the irregular operations information available to users. Thus, the information stored in the main database may be formatted for distribution to the users via a standard distribution method such as web page based distribution. The web server of the main server may be capable of supporting any number of web or computer network based technologies, e.g., Hyper Text Mark-up Language (“HTML”), Java, JavaScript, C/C++, Perl, etc.

The users 20-22 may access the web page hosted by the main server 30 via the communication network 30. The users 20-22 may be able to gain access to the information via a web browser 10 through an advanced user authentication process requiring, e.g., passwords, challenges, network and/or individual computer identification (encrypted), monitoring tools, etc., in order to ensure the security of the system. Other security measures such as redundant web servers with secure socket layer encryption (“SSL”) may also be used as is known in the art.

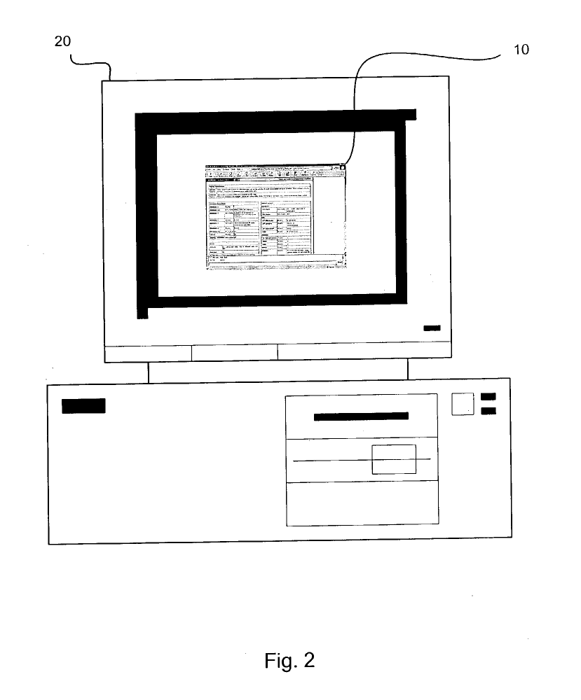

FIG. 2 shows an exemplary user station 20 which is logged into the web page of the main server 30. The display of the information is delivered via the communication network (e.g., Internet) into the web browser 10 of the user station. The present invention may also set a plurality of user-based permissions that gives each user access to only the information and update capabilities for which the user is authorized. For example, the user 20 may have access to all the data contained on the main server 30, while the user 21 may only have access to a specified subset of data.

In another example, the users 20 and 21 may have the ability to input information into the database contained on the main server 30, while the user 22 may only display information. Thus, the users 20-21 are shown as having two way communication with the communication network 50, while the user 22 is shown as having only one way communication. A user with input permission may input information on the web browser 10 via an input device (e.g., keyboard, mouse) and send that information to the main server 30 via the communication network 50. The users 20-21 having input permission may manually enter information through the use of standardized designs, e.g., menu choices. The main server 30 will record any information input by an authorized user in the correct database or database record and the information may then be accessible by all other users (having the requisite permission) that are connected to the main server 30 via the communication network 50. Thus, the exemplary embodiment of the present invention allows for both the acquisition and distribution of information by the users.

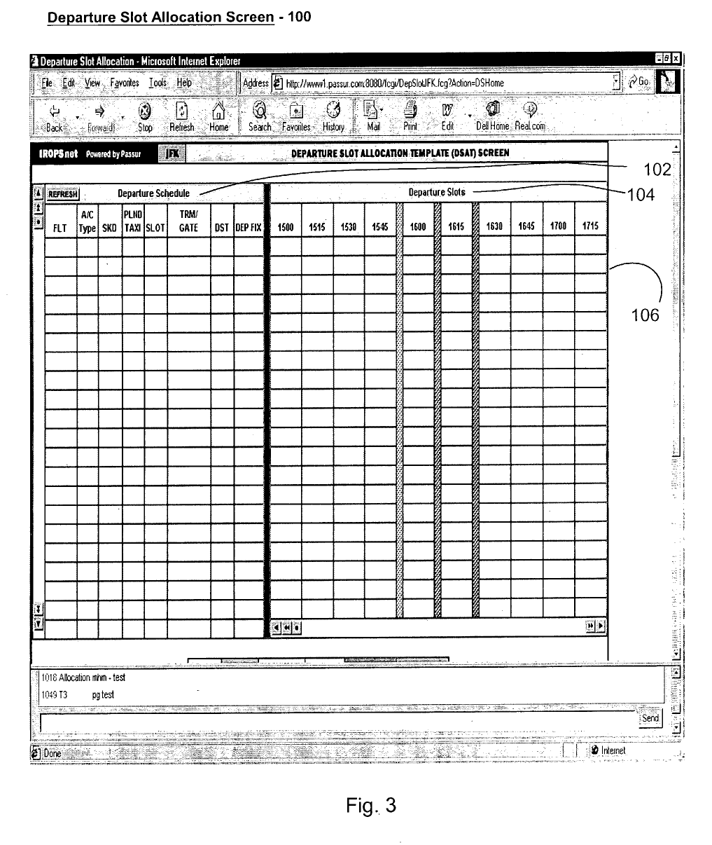

FIG. 3 shows an exemplary screen shot of a departure slot allocation screen (“DSAT”)100. The DSAT screen 100 is an exemplary web page which may be made available to the users 20-22. Those of skill in the art will understand that each of the screens described below are exemplary and that a developer, a system administrator or an individual user may have the ability to design and/or customize screens to display the information in a manner consistent with the users' needs. These particular exemplary screens are described to provide examples of the types of information which may be collected and distributed by the exemplary system 1 during an irregular operation condition. In addition, the particular screen(s) available to individual users may depend on the specific area of responsibility within the airport(s) that an entity has during the irregular operation event. For example, the airport operator may have different responsibilities from the airlines and thus, the information available to the airport operator may be different from that available to the airline.

As described above, not all of the users 20-22 may have permission to view the DSAT screen 100, only those users authorized to view this particular information. The DSAT screen 100 may include a Departure Grid 102 having flight information, runway taxi information, terminal/gate information, destination, etc. The DSAT screen 100 may also include a Departure Slots Grid 104 having Departure Queue Boxes 106. Other information which may be included on the DSAT screen may include Airport Authority Key Information, Airline Information and free form text boxes for remarks. As will be described in greater detail below, the information for these grids and other information may be linked from other pages.

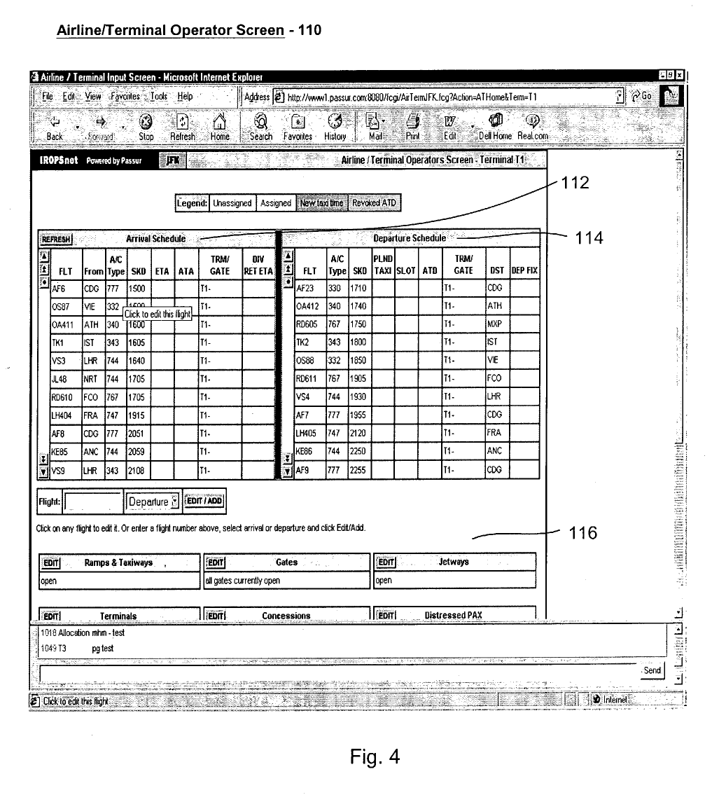

FIG. 4 shows an exemplary screen shot of a airline/terminal operator screen (“ATO”) 110 according to the present invention. The ATO screen 110 may include a flight schedule arrivals information grid 112 having information such as flight number, scheduled arrival time, estimated time of arrival (“ETA”), actual arrival time, terminal/gate number and diversion update. The ATO screen 110 may also include a flight schedule departures information grid 114 having information such as flight number, scheduled departure, estimated departure, actual departure, and terminal/gate number. The ATO screen 110 is also shown as including facilities status information areas 116 having information such as ramps/taxiways, gates, jetways, terminals, concessions, distressed passengers. Those of skill in the art will understand that the information shown on the various exemplary screens is only for illustrative purposes, individual users and/or developers may include any information on screens as required for irregular operations.

As shown in FIG. 4, a user may enter information into the ATO screen 110. The facilities status information areas 116 may have menu options for the users to enter information. For example, a user may click the edit button on the ramps/taxiways information and a menu may appear for the user to enter information. Those of skill in the art will understand that there may be numerous manners of entering information into any particular screen, e.g., menus, pull-down menus, typing fields, selection boxes, etc. The ATO screen 110 may also include an Airline/Terminal Operator Introductory page where a user may enter a terminal name and an operator name and password, in order to enable access to a specific, designated ATO screen 110. For example, a regional airport authority may operate several local airports and the exemplary system 1 may be operational to serve each of these local airports during irregular operations. An exemplary airline (Airline A) may operate only out of one (1) terminal at one (1) of these local airports. Thus, when an authorized user from Airline A logs into the system 1, the user may go to the introductory page and enter the required information. Since Airline A may only be concerned about operations at the one terminal and/or airport at which it is operating, the ATO screen 110 which is displayed to this user may only contain information for this terminal and/or airport. In contrast, an authorized user of the regional airport authority may desire to view the ATO screens 110 for all the terminals of all the local airports for which the authority is responsible.

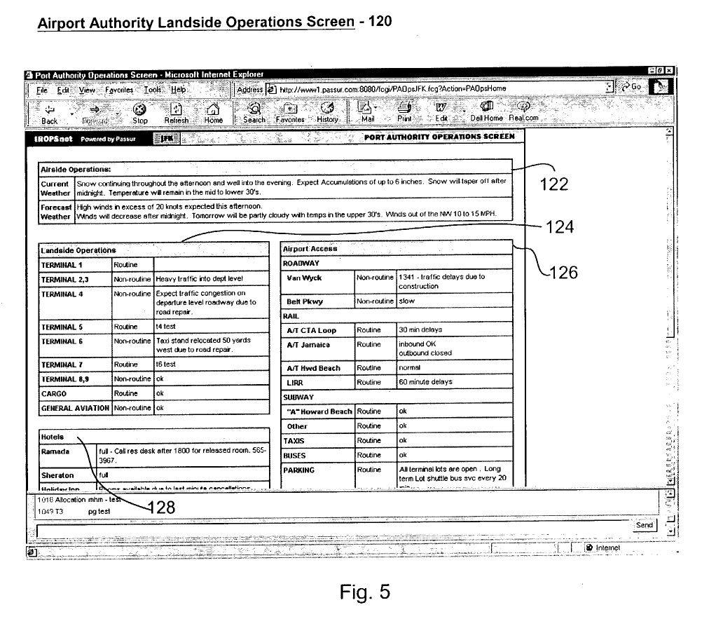

FIG. 5 shows an exemplary screen shot of an airport authority landside operations (“AALO”) screen 120 which may include a weather information area 122 which displays weather information in a text format (or any other format selected by the user and/or developer) that may be updated via link to an external data source such as the National Weather Service. The AALO screen 120 may also include landside operations area 124 which is separated by terminal with selection for routine and non-routine information, airport access information area 126 (e.g., roads, rail, taxi, subway, bus) with selection for routine and non-routine information, hotel room availability information area 128, a free form general remarks box area (not shown), etc.

Routine information may be considered information which signals a regular or expected occurrence for a particular information field. The individual system operator (e.g., the airport, regional airport authority, etc.) may determine which information is routine for a particular installation of the system 1. For example, it may be determined by the system operator that only truly normal occurrences are routine, e.g., all airport systems are operating at maximum efficiency. Whereas, in an alternative example, as shown in the airport access information area 126 of this exemplary embodiment, it may be considered routine that some of the rail connections to the airport are experiencing delays (e.g., LIRR having a routine 60 minute delay). A user of the system 1 may ignore any information which shows up as routine, since the user knows that this particular airport parameter is operating in a usual manner and does not need any extra attention.

In contrast, non-routine information is information which indicates something out of the ordinary or unexpected is occurring. For example, in the landside operations area 124, it is considered non-routine that there is a heavy traffic situation at terminals 2,3. By allowing the authorized users to view these normal and non-normal situations that are occurring throughout the airport, it will allow the users to better respond to an irregular operation condition. For example, if the airport operator is aware of the traffic congestion at terminals 2 and 3 in a real time situation, the airport operator may be able to reallocate traffic control personal to address the situation, contact the appropriate entities to make passengers aware of the traffic problems so the passengers may avoid the congestion, etc.

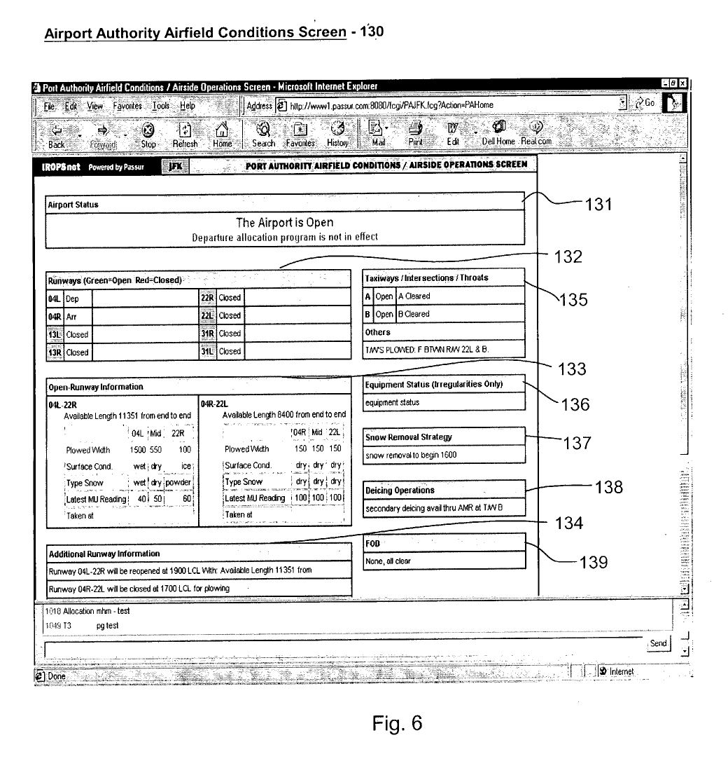

FIG. 6 shows an exemplary screen shot of an airport authority airfield conditions (“AAAC”) screen 130 which may include airport status area 131 which may display open/closed status, expected re-opening information, a runway status area 132 displaying the present status of each runaway, a runway conditions information area 133 to display specific information about a selected runway, an additional runway information area 134 to display additional information about a selected runway, a taxiway/intersection/throats information area 135 displaying the status of these areas within the airport, an equipment status area 136, a snow removal information area 137, a deicing operations information areal 38 and a runway reopening information area 139. Each of these areas may have remarks areas where authorized users may insert remarks which may aid other users of the system 1 during an irregular operation condition.

Other examples of web pages or screens which may be made available to users may include an automated link to an Official Airline Guide screen to enable quick entry of flight schedules. The information from the Guide screen may be linked to the ATO screen 110 and then further linked to the DSAT screen 100 and other appropriate locations on the website. In addition, a Federal Aviation Authority/Air Traffic Controller (“FAA/ATC”) screen may be included to track surface movement arrivals area (including runway in use, critical/preferred taxiways, estimated taxi time), surface movement departures information area (including runway in use, critical/preferred taxiways, estimated taxi time), air operations arrivals (arrival routings, fixes, gateways), air operations departures (departure routings, fixes, gateways), expected departure clearance times, departure sequencing program in effect, and coded departure routes.

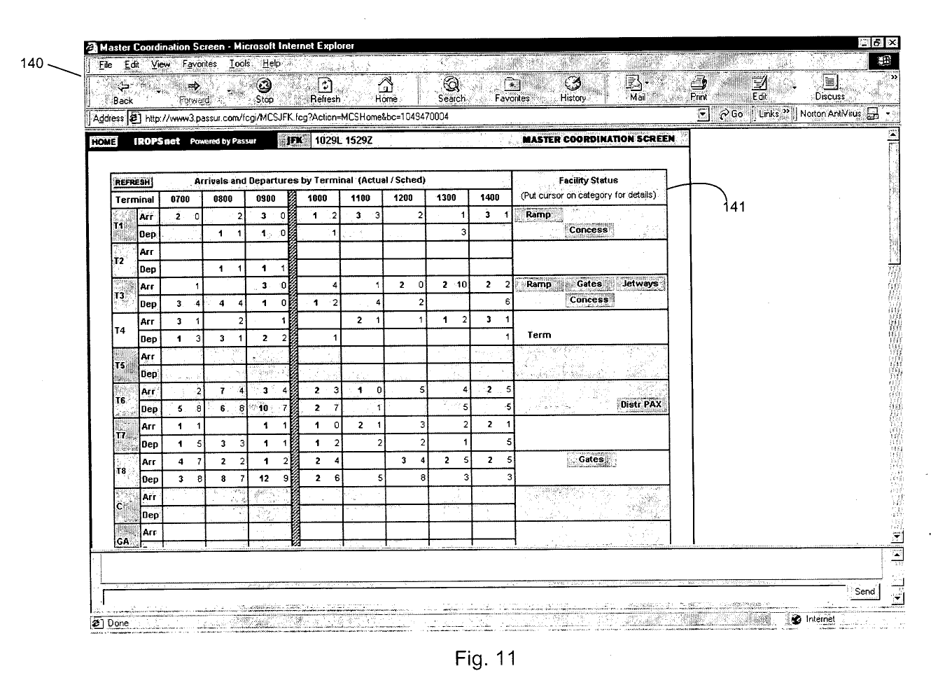

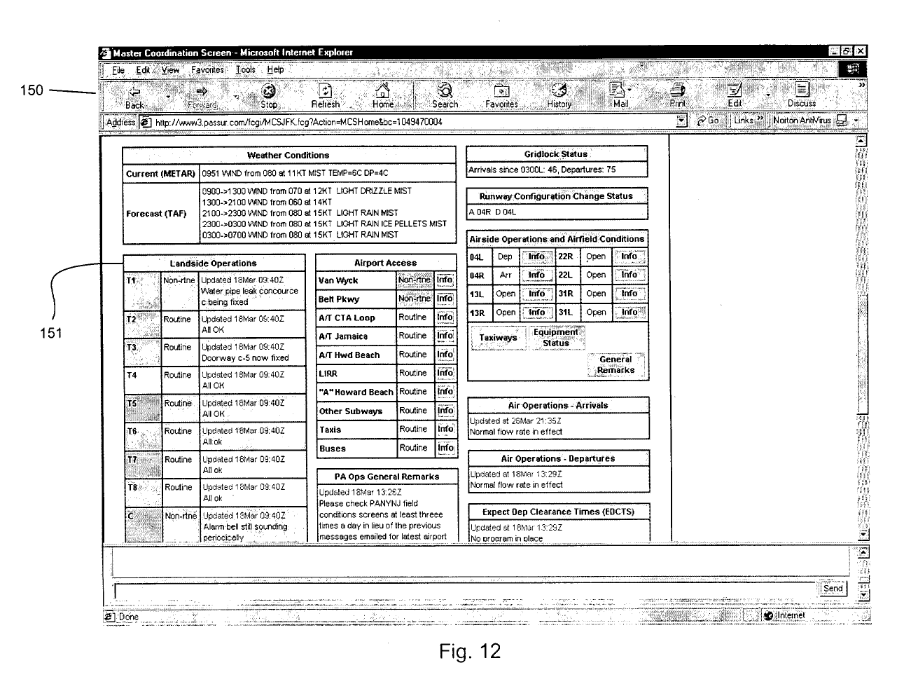

FIGS. 11 and 12 show two different views 140 and 150, respectively, of a Master Coordination (“MC”) screen. The MC screen may include Arrival/Departure grid totals grouped by terminal and by hour, and total arrivals and departures by hour (reflecting cumulative totals which may be derived from data links to individual terminal/airline operator sheets), a moving time line bar; facility status remarks, departure allocation program indicator, arrival and departure runway configurations, arrival fixes, current weather, snow removal strategy, equipment status, gridlock status alerts, landside operations, airport access information, airside and airfield conditions, hotel information, etc. Not all of the exemplary information listed above is displayed in the exemplary views 140 and 150 of FIGS. 11-12, these views 140 and 150 show a portion of the information which may be displayed by the MC screen. The MC screen may also include links to all other information areas.

The MC screen (as well as the other screens) may incorporate color coding to alert users of specific problems or status. For example, in the view 150 showing the landside operations box 151, when a terminal operation goes into a non-routine operation, the box indicating routine/non-routine may change color alerting the user to the non-routine situation. The color coding may also be used to distinguish different types of information (e.g., airside information, landside information, etc) and/or to distinguish subtypes of information (e.g., each terminal has its own color, etc.).

In addition, the MC screen may incorporate a management by exception technique, i.e., if the status of a particular parameter is normal, the MC screen will not display any message or message box for the particular parameter. An example of this is shown in the facility status area 141 of view 140 (FIG. 11). The facility status area 141 shows a series of boxes for each terminal (e.g., for terminal 1, the boxes RAMP and CONCESS are displayed). These boxes indicate that there is a non-routine condition for these parameters at terminal 1. If the status were normal for the parameter, no box would appear in the facility status area 141. Thus, if a box appears, the user is alerted to a non-routine situation. Conversely, if no boxes appear, the user is assured that the parameters are normal.

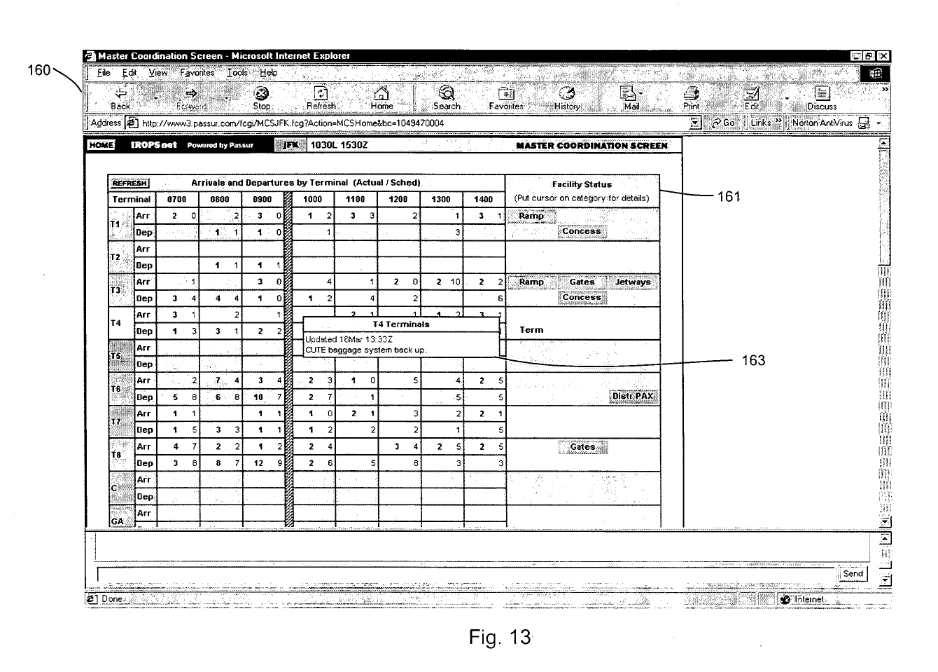

FIG. 13 shows another exemplary view 160 of the MC screen. This view 160 is virtually identical to the view 140 shown in FIG. 11, except that this view 160 shows the implementation of pop-up technology on the MC screen. In particular, the facility status area 161 shows a series of boxes including the box TERM for terminal 4. The use may place a curser over any of the boxes to receive additional information about the alert. In this example, the user placed the cursor over the TERM box and the pop-up box 163 appeared to provide the user with additional information on the alert. In this example, the alert indicates that the CUTE baggage system is back up at terminal 4 and shows the time when that message was posted. Thus, when a user sees a new alert status box appear, the user may ascertain additional information using the pop-up technology incorporated into the MC screen.

The MC screen (and each of the other screens) may also incorporate a chat technology. The chat technology allows users to chat in real time with other users by typing messages on a box provided, for example, at the bottom of the screen. The chat technology enhances the virtual meeting function of the system 1 by allowing users to not only see information in real time, but to discuss the information with other users regardless of the physical location of each user.

The information that is input by the users, for example, on any of the above described screens, may be entered and stored in the main database(s) on the main server 30. In addition to each user having access to the information input by other users via the communication network 50, the connection allows the information to be updated on different pages presenting the same information. As described above, the same information may appear on multiple screens, e.g., the DSAT screen 100 and the ATO screen 110 both have departure grids. Each web page may have redundant database synchronization which automatically updates the page and the information present without user intervention. In order to alert the user of the automated changes made to the information, a notification method such as, for example, color-coding may be implemented to indicated information that is updated or which has become stale. The screens may be set to automatically refresh when any field is updated.

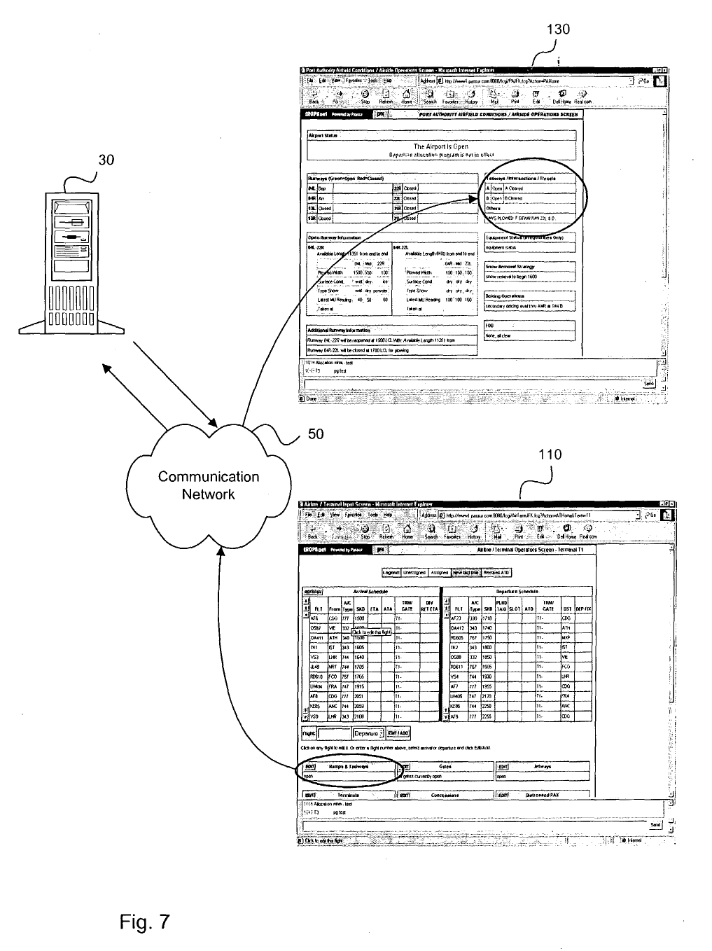

FIG. 7 shows an exemplary update of information across different pages. For example, a user logged into the ATO screen 110 may input information into the ramps and taxiways area (circled area). This information is relayed through the communication network 50 to the main server 30 which updates the main database(s). Any other web pages which contain this information may then be automatically updated. In this example, the AAAC screen 130 contains the ramps and taxiways information (circled area). Thus, the web server on the main server 30 automatically updates the ramps and taxiways information and this updated information is sent via the communication network 50 to the user(s) that are logged into the AAAC screen 130. The local web browser at the user location displaying the AAAC screen 130 may then refresh the screen and display the updated information in a color coded scheme to inform the user which information has been updated.

Referring back to FIG. 1, the data feed arrangement 40 may automatically feed data from an outside data source, for example, a PASSUR™ System by Megadata Corporation of Babylon, N.Y., the ASD data feed provided for resale from the FAA, etc. The PASSUR™ System is a passive radar, which, without emitting any active signals, receives aircraft identification and altitude information from aircraft transponder transmissions, which are interrogated by existing secondary surveillance radars. More information on the PASSUR™ System is provided by Megadata Corporation at www.passur.com. As described above, the data feed arrangement 40 may input the information via the communications network 50 or by a direct connection to the main server 30. Similar to the data input by users, the data that is input from the data feed arrangement 40 is entered and stored in the main database(s) in the main server 30. The information fields on the various screens and web pages may then be automatically updated in the same manner as described above with reference to FIG. 7. Thus, the users 20-22 may automatically access and view the most updated information provided by the data feed arrangement 40.

Exemplary information that may be linked and updated by the data feed arrangement 40 may include, for example, flight numbers, aircraft type, estimated arrival time (“ETA”), actual arrival time, actual departure time, arrival and departure rates, arrival and departure runway configuration, airborne locations, positions, altitudes, runway configuration change alert and gridlock alert (based on preset parameters of arrival and departure rates), origin/destination information, etc.

Those of skill in the art will understand that the data collection function of the system 1 may occur at all times during operation of the airport, not only during irregular operations. The purpose of collecting the information at all times is so that when an irregular condition occurs, the system 1 has the most current information available to display and distribute to users. Furthermore, the users of the system 1 may also have the system 1 operational for using during normal day to day operations. The information available from the system 1 may be helpful during normal operations and during irregular conditions. Thus, the main server 30 may be collecting information from the data feed arrangement 40 and the input user screens described above during any operating condition of the airport. In addition, the system 1 may incorporate redundant databases and redundant servers in order to insure that the information is complete and correct using techniques such as redundant database synchronization.

The exemplary embodiment of the present invention alleviates the need for multiple phone calls, conference calls, and separately staffed irregular operation situation rooms. An Internet or web page based implementation would be familiar and generally known to multiple users such that the log-on and log-off procedures, the use of the interface and the format of displayed information would be familiar to those who use the Internet resulting in a minimal amount of software training for new users. The web based screens provide quick, easy and secure sharing of information considered critical to the effective, efficient and safe operation of the airport and airlines during irregular operations. The system has automated “refresh rates” so that fast-changing, timely information updated by individual users or an automatic data feed arrangement is always available to all designated users.

In addition, since the information is sent via a communications network, users may access the information at all times without being restricted to certain hours of operation. The system 1 offers all the authorized users a virtual meeting space regardless of where they are physically located. This allows authorized users to remotely access the system 1 during normal operations or an irregular condition so that the user is in constant communication and aware of the situation without actually being physically present at the airport. For example, if a key employee cannot make it to the airport during an irregular condition (e.g., during a snow storm), the key employee may still perform their functions because they are able to see the real time status of the airport by viewing the information provided by the exemplary system 1. In a further example, an airline operation center in one location (e.g., Chicago) may be able to know the current situation at an airport anywhere in the country or world (e.g., New York, Tokyo, etc.) because the airline operation center is an authorized user for the system 1 at these airports.

As described above, the system 1 may implement advanced user authentication techniques such as passwords, challenges, computer identification, etc., and data encryption to insure that only authorized users are viewing the information. Furthermore, the exemplary embodiment of the present invention may be implemented using existing hardware and software which is currently available at the airport facility. Thus, no additional software or hardware installation may be required.

In addition, it may be possible to implement the system 1 based on a modular concept. In this exemplary embodiment, the type of information that is collected and distributed during various irregular conditions may be different. For example, the type of information that is needed during a thunderstorm may be different from the type of information that is needed during a security breach at a terminal. Thus, the system 1 may be implemented on a module by module basis where each module is specifically designed to address a particular type of irregular condition (e.g., security breach, passenger emergency, weather condition, airline schedule emergency, etc.). As users determine that a particular module is useful, the module can be added as needed. Since all the information is stored on the databases on the main server 230, the databases may be designed such that additional databases may be added when a new module is installed or the new module may make use of information fields in the current database either by using the existing data or adding data to unused fields. Furthermore, there may be some information commonly used by some or all of the modules. This information may therefore exist in the databases on the main server 230 before any particular module is installed at users' stations.

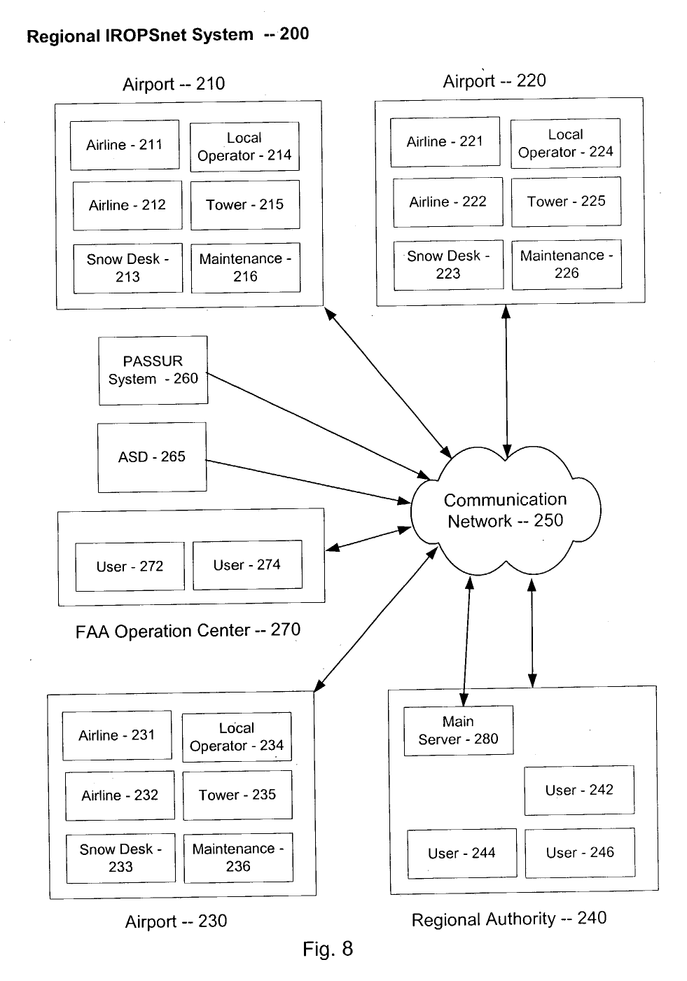

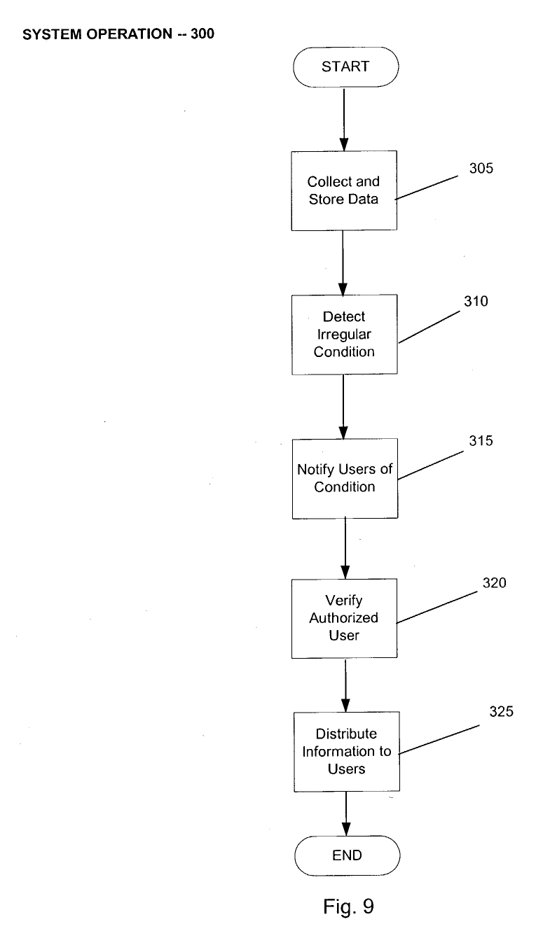

The following will provide an example of the operation of an exemplary embodiment of the present invention. FIG. 8 shows an exemplary embodiment of a regional IROPSnet system 200 which includes three airport facilities 210, 220 and 230, a regional airport authority facility 240 and an FAA operation center 270. FIG. 9 shows an exemplary system operation process 300 for the operation of the IROPSnet system 200. FIG. 8 shows that the main server 280 for the system 200 is housed at the regional authority facility 240 which also includes user stations 242, 244 and 246. The arrow between the main server 280 and the communication network 250 indicates that there is a two-way communication between the main server and the communication network. In addition, the arrow between the communication network 250 and the regional authority facility 240 indicates that there are communications between the communication network 250 and each of the users 242, 244 and 246. As described above, the communication may be either one-way or two-way based on the level of authority granted to each of the users 242, 244 and 246.

The airport 210 shows that there are six (6) authorized uses at the airport. The first two users 211 and 212 are airline users which operate at airport 210, user 213 is associated with the snow desk coordination center of the airport 210, user 214 is the local operator of the airport 210, user 215 is associated with the control tower of the airport 215 and user 216 is associated with the maintenance crew for the airport 210 (e.g., snow removal operators). Those of skill in the art will understand that the users described here are only exemplary and that there may be many other authorized users that are located both at the airport and/or in remote locations. In addition, the users may be part of the same organization as other users (e.g., the maintenance crew user 216 may be associated with the airport operator) or separate entities (e.g., each airline is a separate organization). The arrow between the communication network 250 and the airport 210 indicates that there are communications between the communication network 250 and each of the users 211-216. Similarly, the airports 220 and 230 have users 221-226 and 231-236, respectively, which communicate with the communications network 250. In addition, the FAA operation center 270 has users 272 and 274 which may communicate with communication network 250.

Referring to FIG. 9, during normal operations the main server 280 collects data on the operations of the three airports 210, 220 and 230 (step 305). This information may be collected via inputs from data feed arrangements such as the PASSUR™ System 260 and/or the FAA ASD system 265 or through the manual inputs of any of the users of the system 200. As described above, the system 200 will collect data during both normal and irregular operations to insure that the data displayed to the users during an irregular condition is accurate and timely. Thus, even though it may be considered that the current operations of the airports 210, 220 and 230 are normal, the system 200 may be collecting data and users may be accessing the information contained in system 200. Accordingly, the data collection step 305 is an ongoing process that will be occurring at all times while the system 200 is operational. The data is collected and stored in databases on the main server 280.

In step 310, the system 200 detects an irregular operation condition. This detection of an irregular condition may be made as a result of a manual input by one of the users (e.g., the local operator user 214 at the airport 210 enters the shutdown of a terminal because of a security breach, the FAA forwards a weather advisory from the National Weather Service, etc.) or based on an automatic input from one of the data feeds 260, 265. An irregular operation condition may be a predicted irregular condition (e.g., a snow storm, etc.) or a random occurrence which cannot be predicted (e.g., a thunderstorm, a security breach, etc.). In this example, the irregular condition considered will be a snow storm in the vicinity of the three airports 210, 220 and 230. The purpose of system 200 during the snow storm is the acquisition and distribution of vital information for use by all of the entities associated with the airport so that each of these entities have an instant and common situational awareness of the current status of the airport. This awareness will result in shorter and less frequent delays for passengers and a faster return to normal operations for the airport.

Thus, when the snow storm is predicted each of the users may be notified of the irregular condition (step 315). The notification may be an electronic mail (“e-mail”) or a page to each of the users indicating that there is an irregular condition and that they should log into the system 200 for information concerning the condition. In step 320, the system 200 will verify that the users that are attempting to log onto the system 200 are authorized users and the level of each authorized user. For example, each of the users 211-216 at airport 210 may attempt to log onto the system 200 after receiving the notification of the irregular condition in step 315. The log on attempts will be communicated to the main server 280 through the communication network 250. The main server 280 will verify the authenticity of each of the users 211-216 and grant access to the information contained on the main server 280 based on the level of each of these users. For example, the airline users 211 and 212 may only be allowed to view information concerning their own flights and airplanes. Similarly, the maintenance user 216 may only be allowed to view maintenance information related to the specific airport 210 and may only be able to enter information concerning the availability of snow removal equipment and the status of snow removal on runways (e.g., update that a runway has been cleared, etc.). The level of access granted to the user may be determined based on the responsibility of that user during a particular irregular condition.

After the user is verified and logged on, the system 200 will distribute information to the users as needed (step 325). Continuing with the snow storm example, the maintenance user 216 may indicate through input screens that only 75% of its snow removal equipment is operational. The local operator 214 of the airport 210 may determine that the most efficient use of this equipment is to keep only a certain portion of the available runways operational and close the other runways. The local operator 214 may indicate the closures of the other runways by entering the appropriate information into the system 200. The system 200 may then automatically update these runaway closures and the tower user 215 may see these runway updates so that they may re-direct departures and arrivals to those runways which are remaining open. The airline user 211 may view the runway closures and determine that a certain percentage of its flights may not depart. The airline may then cancel those flights and inform passengers as early as possible so the passengers may make alternate plans.

In addition, the airline user 211 may indicate its flight cancellations so that the snow desk coordination center 213 may delete these flights from the schedule and reallocate those departure times to other flights which may have been delayed due to the runway closures. This reallocation of departure times may be performed in a dynamic and expedited manner using the system 200.

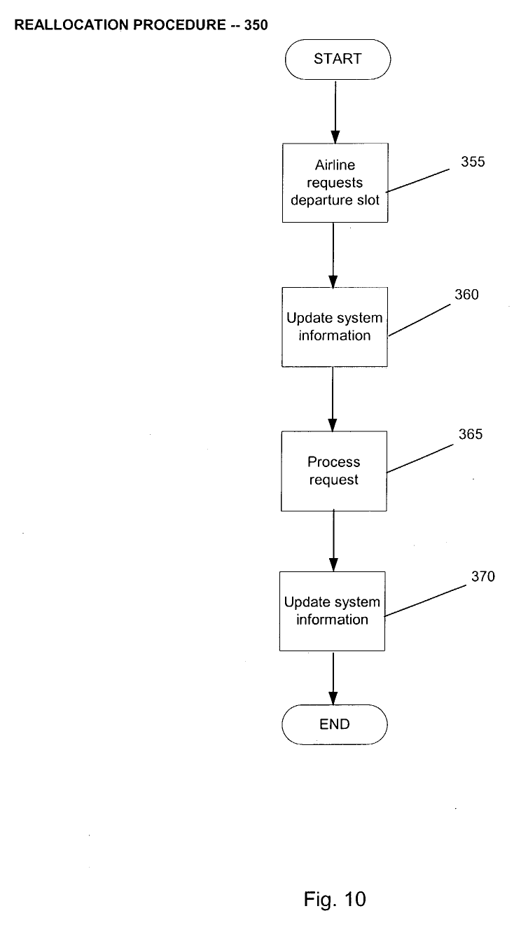

FIG. 10 shows an exemplary process 350 for re-allocating departure slots using the system 200. In the first step 355, an airline operator (e.g., airline 211) may make a request to the snow desk coordination center user 213 for a particular departure slot. The airline user 211 may see the departure slots, for example, by viewing the departure schedule 114 on ATO screen 110 or by viewing the departure slots grid 104 of the DSAT screen 100. In this embodiment, the airline user 211 may view the DSAT screen 100, but does not have permission to enter data. Thus, the airline user may enter the request on the ATO screen 110.

In step 360, the system 200 is updated based on the input of the request by the airline user 211. This update may be viewable by all users of the system 200 meaning that each user may see that airline user 211 requested a particular departure slot. Other users (e.g., airline user 212) may then determine not to request the same departure slot. The snow desk user 213 may see the request on the DSAT screen 100. The request may be color coded to indicate certain information to the snow desk user 213 (e.g., airline, pending request, etc.). The DSAT screen 100 may display all the departure slots in various color codes to indicate certain information. For example, a white display may indicate that the aircraft has taken off, a blue display may indicate that the departure is scheduled and pending, a red display may indicate a request from an airline for a departure slot, etc. Thus, in this example, the request by airline 211 is pending and viewable on the system 200.

In step 365, the snow desk user 213 may process the request. For example, the snow desk user 213 may analyze the request against a set of departure rules designed to efficiently allocate departure slots and determine whether to grant the request, deny the request or move the request to a different departure slot. For example, the snow desk user 213 may determine that based on the departure rules, the airline 211 should be granted the requested departure slot. In this case, the snow desk user 213 using the DSAT screen 100 may move the request into the requested departure slot using, for example, standard point and click capabilities. In this example, the snow desk user 213 has the authority to both view and input data into the DSAT screen 100.

The process may then continue to step 370 where the system 200 is once again updated to indicate that the airline 211 has been granted its requested departure slot. The request may be displayed on the DSAT screen 100 and the ATO screen 110. Again, the updated views are available to all authorized users so that they may determine the status of the request and the current status of the departure slots. The updated views may also show the granted request in a different color to indicate the request has been granted.

However, if in step 365, it was determined that the request should be denied, the snow desk user 213 may enter the appropriate denial actions on the DSAT screen 100 and in step 370 this denial will be indicated by the update of the views for system 200. The denial may be seen by all users and the request may be color coded to indicate that it was denied. In a further example, the snow desk user 213 may not deny the request, but move the request to a different departure slot than the requested slot. If this occurs, the system 200 will be updated and the users will be able to view the slot which was granted to the airline 211 based on the request.

Those of skill in the art will understand that the above example showed a single request for the re-allocation of a departure slot and that there may be many requests and/or re-requests made for departure slots simultaneously or nearly simultaneously and that the system 200 may be updated in a real time manner to handle these requests. Each request and/or re-request may be handled using the exemplary process 350. In addition, the airline user 211 may indicate a cancellation by making a request to remove a flight from a departure slot and the same updating process will be used to indicate that the departure slot is now open.

Furthermore, the snow desk user 213 may re-allocate departure slots based simply on the set of rules without receiving a request from the airlines and this may be communicated immediately to all the airline users. For example, the snow desk user 213 may become aware that a runway will become unavailable for 15 minutes. Using the DSAT screen 100, the snow desk user 213 may move all the entries in the departure slots ahead an increment of 15 minutes to account for the runway unavailability. The DSAT screen 100 may have a standard cut and paste or move graphical capability which allows for a simple re-allocation by the snow desk user 213. After the snow desk user 213 has made these changes, the system 200 is automatically updated and each of the users may see the updated departure slot schedule in real time. Airline users may use this information and quickly inform its passengers of updated boarding and departure times.

As can be seen from the above example, one simple entry into the system 200 (e.g., 75% of the snow removal equipment is operational) can cascade into numerous events which may disrupt the operation of the airport 210. In addition, the events at one airport 210 may effect the operation of the other airports 220 and 230 (e.g., as flights may have to be diverted to the other airports, etc.). The possibilities of the cascading of events at the three airports are endless based on events and reactions to events. However, the system 200 provides for each of these events to be viewed simultaneously by each of the users in real time which allows each of these users to act based on the events commensurate with their responsibilities.

A specific example of a direct benefit of the system 200 during a snow storm may be the elimination of costly secondary de-icing operations. During a snow storm, it is normal for a plane to undergo a primary de-icing operation to prevent ice buildup on the plane. However, if the plane is waiting for longer than a specified time without taking off, the plane needs to undergo a secondary deicing operation. These operations are expensive and further delay the plane from taking off. The use of system 200 allows for the efficient management of departure slots and a more efficient operational flow so that the airline operators will know the optimal time to perform the primary de-icing operation and insure that the plane takes off prior to the time when a secondary deicing is required. This results in both a cost saving to the airline and the maintenance of a regular departure schedule during the irregular event.

A second example of a benefit of the system 200 during an irregular condition may be the prevention of plane diversions, i.e., the plane cannot land at its intended airport. A diversion is very expensive for the airline since it now needs to pay for the landing at a different airport and causes a major inconvenience for the passengers. Again, the system 200 can manage the flow rate through an airport such that a bottle neck of no runways or too many planes in the air does not occur. For example, if it is determined that a buildup of planes in the air is occurring, the departure slots may be easily reallocated (as described above) to hold takeoffs so that planes in the air may land. The user of the system 200 (e.g., the airlines, the tower, etc.) may automatically view this reallocation and act accordingly.

As can be seen from the exemplary benefits and examples of the types of information which may be collected by the exemplary embodiments of the present invention which were described herein and as shown in the exemplary screens of the drawings, the amount of information available to the users allows the user to make the best possible decisions. These decisions may vary from the extremely important (e.g., when to close the airport) to the mundane (e.g., which hotels have room availability), but the exemplary embodiments of the present invention allows these decisions to be made with a full understanding of the status of the airport during these irregular conditions because of the effective collection and dissemination of information. Furthermore, this information is disseminated in an efficient simultaneous manner and alleviates the need for making separate communications to multiple entities to communicate the same information.

In addition, because all the data is collected and stored in a central location, the data and reactions to the event may be viewed at a later time in order to evaluate the effectiveness of the responses to the event. Such an evaluation may lead to the institutions of certain training and procedures to deal with various irregular conditions, thereby promoting a more efficient response to these conditions.

As described above, the system 200 may have the ability to notify users remotely upon the occurrence of an irregular condition. The system 200 may also have the ability to send messages to users which display certain parameters. Each user may define the parameters to which they want to be alerted. The alerts may be sent via wired or wireless methods to alert users on PDA's, mobile phones, pagers, etc. For example, a particular user may request that a message be sent to the user when there is a change in the departure schedule, when a runway is closed, when a transportation system goes into a non-routine operating condition, when all hotels are full, etc. In addition, certain information may be directly sent to public locations such as public information display screens at the airport, the airport website, etc.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A system, comprising:
a first computing device receiving data from an input feed, the data corresponding to operating parameters of an airport facility, the first computing device organizing the data into files which are viewable by users of the system; and
an additional computing device connected via a communication network to the first computing device, receiving the files organized by the first computing device and displaying the files to a user.

2. The system according to claim 1, wherein the communication network is one of an Internet, an intranet, a local area network and a wide area network.

3. The system according to claim 1, wherein the additional computing device receives the files via a web browser resident on the additional computing device.

4. The system according to claim 1, wherein the additional computing device includes a plurality of computing devices, each of the plurality of computing devices configured to display the files.

5. The system according to claim 1, wherein the input feed is one of a manual input by the user of the system and an automatic input from a data collection system.

6. The system according to claim 1, wherein the files are organized into subsets corresponding to an irregular operating condition of the airport facility and the additional computing device receives a subset of files based on an actual irregular operating condition of the airport facility.

7. The system according to claim 6, wherein one of the files is a member of at least two subsets of files.

8. A method, comprising the steps of:
collecting data corresponding to operating parameters of an airport facility;
organizing the data into files which are viewable by users; and
distributing the files to a user device for the user to display the files.

9. The method according to claim 8, wherein the operating parameters include one of a ground operation status, an air operation status, a runway activity status, a departure slot allocation schedule, a taxiway route status, an arrival rate, a departure rate, a snow removal status, an equipment status, a flight number, an aircraft type, an estimated arrival time, an actual arrival time, an actual departure time, an arrival runway configuration, a departure runway configuration, an airborne location and an altitude.

10. The method according to claim 8, further comprising the step of:
verifying the authenticity of the user prior to distributing the files to the user.

11. The method according to claim 8, further comprising the steps of:
assigning a file clearance level to each of the files; and
limiting the distribution of files to the users based on a user clearance level.

12. The method according to claim 8, wherein one piece of data is shared by at least two files.

13. The method according to claim 12, wherein, when the one piece of data is superseded by a newly received piece of data, the at least two files are simultaneously updated.

14. The method according to claim 8, further comprising the steps of:
detecting an irregular operating condition of the airport facility based on the data corresponding to the operating parameters; and
notifying the user of the irregular operating condition.

15. The method according to claim 14, wherein the user is notified via an electronic mail message.

16. A system, comprising:
a data receiving arrangement to receive data corresponding to operating parameters of an airport facility;
a data storage arrangement to store the data received by the data receiving arrangement;
a data organizing arrangement to associate each piece of data with a corresponding file; and
a data distribution arrangement to distribute the file to users of the system.

17. The system according to claim 16, wherein the data distribution arrangement distributes the file via a communication network which is one of an Internet, an intranet, a local area network and a wide area network.

18. The system according to claim 16, wherein the data distribution arrangement is a web server.

19. The system according to claim 18, wherein the file is a web page.

20. The system according to claim 16, wherein the data storage arrangement is a database.

21. The system according to claim 16, further comprising:
a data generation arrangement to analyze a subset of the received data and generate additional data to be distributed with the file.

22. The system according to claim 21, wherein the additional data includes an airline departure slot schedule.

23. The system according to claim 16, wherein, when the data receiving arrangement receives new data which updates a previously received piece of data, the data organizing arrangement associates the new data with the file and the data distribution arrangement to distributes the updated file to the users of the system.

24. The system according to claim 16, wherein the distribution of the data in the file is based on an irregular operating condition of the airport.
